(19) United States
(12) Patent Application Publication
(10) Pub. No.: US 2012/0233541 A1
(43) Pub. Date: Sep. 13, 2012

(54) RENDERING A WEB PAGE COMPRISING PLUG-IN CONTENT

(75) Inventors: Christian Maria Johannes Ar Quaedvlieg, Eindhoven (NL); Michel De Vries, Eindhoven (NL)

(73) Assignee: KONINKLIJKE PHILIPS ELECTRONICS N.V., EINDHOVEN (NL)

(21) Appl. No.: 13/501,917

(22) PCT Filed: Nov. 16, 2010
(86) PCT No.: PCT/IB2010/055186

§ 371 Date: Apr. 13, 2012

(30) Foreign Application Priority Data
Nov. 20, 2009 (EP) 09176571.9

(51) Int. Cl. G06F 17/00

(52) U.S. Cl. 715/234

(57) ABSTRACT

A method and system are described of rendering a web page comprising plug-in content. A predetermined operation is performed for only the visible plug-in content and the non-visible plug-in content is ignored. The predetermined operation is either the step of enabling a user to select the plug-in content (130) or the step of automatically playing the plug-in content (155).

### BACKGROUND OF THE INVENTION

1. Technical Field

The present invention relates to the field of rendering content of web pages and more specifically to rendering plug-in content thereof.

2. Description of Related Art

Some high-end television sets currently enable the user to surf the open Internet. Examples thereof are the Philips television sets in the 8000 series, 9000 series and Cinema 21:9, which offer the NetTV® feature. A description of the NetTV® feature is available at “http://www.digitalnewsroom.philips.com/products/net-tv/. Through Net TV®, Internet content is tailored for the best possible viewing experience on the TV screen, and is easily accessed through the TV's remote control, without the need for extra set-top boxes or service subscriptions, or for starting up a PC. The user is provided the option to surf the web freely, i.e. type any URL, but there are some restrictions and limitations compared to surfing the web with a PC. Neither downloading nor uploading of files is possible and there is no plug-in support.

### SUMMARY OF THE INVENTION

It would be desirable to support the rendering of plug-in content, i.e. web content that cannot be initialized without installing a plug-in, i.e. an auxiliary computer program configured for handling the content (e.g. Adobe Flash). With plug-ins, it is possible to play streaming video, play online games, or listen to online music.

A downside of plug-in content is that it often requires high processor and memory resources to perform, properly. The generally limited processing and memory resources of high-end TV sets would render it cumbersome to provide full support for all plug-in content items found on one page. Due to the concurrent attempt of all plug-in content items to initialize, all available CPU and/or memory resources would be consumed. The system would then become slow and there would even be a risk of the browser/plug-in being closed.

Therefore, there is a need to apply a more intelligent approach to initiate plug-in content, in particular for devices having relatively limited processing and memory resources, in order not to overload device resources during page load.

To better address this concern, according to an aspect of the invention a method is provided of rendering a web page comprising plug-in content, the method comprising the step of, when a location of plug-in content becomes visible in a current view of the web page, performing a predetermined operation related to the plug-in content corresponding to the location. Normally, when a user browses a web page not the whole web page is visible but only a part thereof. The ignoring of the plug-in content at locations in the web page, which are not (yet) visible in the current view thereof, results in important savings in processor and memory use. This is particularly useful for consumer electronic devices having limited processing and memory resources, such as television sets low-end PCs, mobile telephones and net-books, because there is a reduced risk that the device becomes slow or needs to close the browser/plug-in.

According to an embodiment of the present invention the predetermined operation is playing the plug-in content. Consequently, the plug-in content is directly played when it becomes visible and no user action is needed.

According to an alternative embodiment of the present invention the predetermined operation comprises the step of enabling a user to select the plug-in content corresponding to the location for playing. By playing only the plug-in content that is desired by the user, further savings are obtained in processor and memory use.

The step of enabling comprises initializing at least one of the plug-in content corresponding to the location for playing and the plug-in needed to play the plug-in content corresponding to the location. By initializing only the plug-in automatically and not the plug-in content, processor load becomes nil after the initialization and no memory resources are reserved for the plug-in content. However, the user is not provided beforehand (i.e. before selecting the content for playing) with information regarding the content at that location. In case that also the plug-in content is initialized, the user is provided with information regarding the content before selecting it for playing. This results in a slightly reduced saving of memory use, because memory is reserved for the initialized content. Preferably, the initializing plug-in content is paused and the user is enabled to select the paused plug-in content for playing. The paused plug-in content is played upon the selection.

According to a further embodiment of the invention, the playing of the plug-in content is discontinued, when the playing plug-in content becomes invisible in a current view of the web page. Indeed, when due to the user scrolling this content is not visible anymore, there is no need to continue playing it. The effect is a further reduction of processor and memory use.

Preferably, the method according to the invention is implemented by means of a computer program.

The computer program may be embodied on a computer readable medium or a carrier medium may carry the computer program.

According to a further aspect of the invention, a system is provided comprising a controller for rendering a web page comprising plug-in content, wherein the controller is configured for performing a predetermined operation related to plug-in content, when a location of the plug-in content becomes visible in a current view of the web page.

The controller can implement the method described above and can render the web page, accordingly. Consequently, the advantages resulting from the method can be achieved. Moreover, the controller can be modified so as to realize the preferred variants of the method described above.

These and other aspects of the invention will be apparent from and elucidated with reference to the embodiments described hereinafter.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 shows a flowchart of rendering a web page comprising plug-in content according to a first exemplary embodiment of the invention.

FIG. 2 shows the rendering of the web page on a TV screen.

FIG. 3 shows a flowchart of rendering a web page comprising plug-in content according to a second exemplary embodiment of the invention.

FIG. 4 shows a flowchart of rendering a web page comprising plug-in content according to a third exemplary embodiment of the invention.

FIG. 5 shows a flowchart of rendering a web page comprising plug-in content according to a fourth exemplary embodiment of the invention.

FIG. 6 shows a block diagram of a system for rendering web pages comprising plug-in content according to an exemplary embodiment of the invention.

Throughout the figures like reference numerals refer to like elements.

### DETAILED DESCRIPTION OF THE PRESENT INVENTION

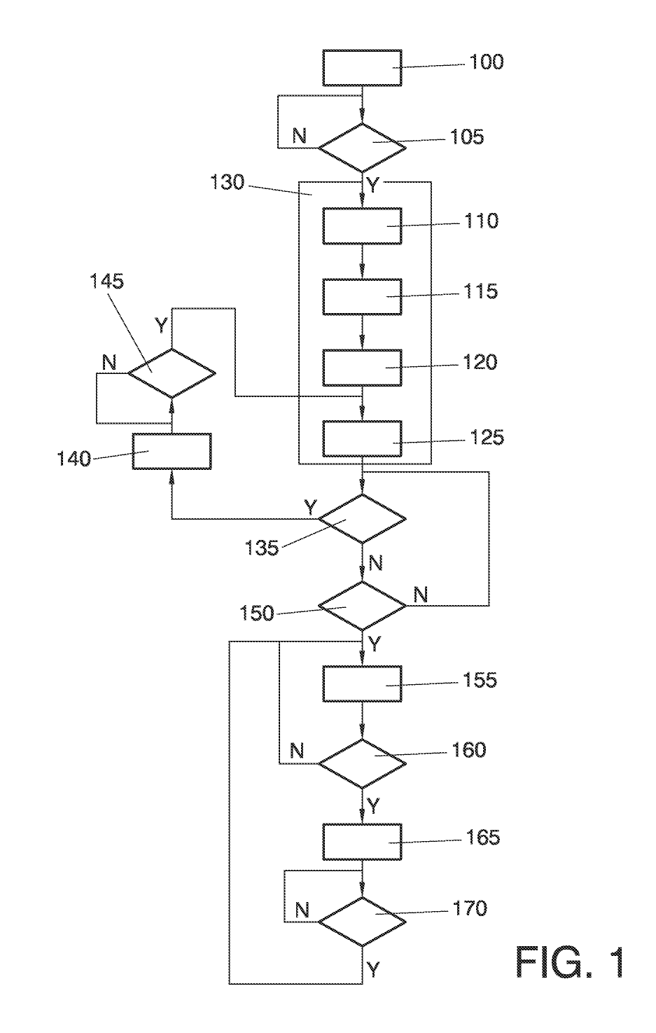

FIG. 1 shows a flowchart of rendering a web page comprising plug-in content according to a first exemplary embodiment of the invention. The web page is loaded and the “normal” (i.e. “non plug-in”) content thereof is rendered (step 100) by a web browser. It is determined if a location of any of the plug-in contents contained in the web page becomes visible in a current view of the webpage on a TV-screen (step 105). Thereto, the position of the HTML elements or objects in the web page representing the plug-in content is monitored. The current view of the web page changes because of user scrolling. Plug-in content at locations that are not (yet) visible is ignored. If a location of plug-in content becomes visible, the corresponding plug-in is initialized (step 110). Downloading of the plug-in content is started and one or a few frames thereof are played (step 115). The plug-in content is paused (step 120) and made selectable (“clickable”) (step 125), in order to be able to play the content again (after clicking) By playing one or a few frames of the selectable plug-in content and then pausing it, the user is provided with an image representing the plug-in content. This is helpful for the user in deciding which plug-in content should be selected for playing and which plug-in content should not. The steps 115 and 120 together correspond to the initialization of the plug-in content. The steps 110,115,120 and 125 together correspond to the enabling of the user to select the plug-in content corresponding to the location for playing (step 130).

Next, it is determined if the plug-in content becomes invisible again (step 135). If this is the case, it is made non-selectable (step 140). It is then determined if the plug-in content becomes visible, again (step 145). If this is the case, it is made selectable again (step 125). If the plug-in content remains visible, it is determined if a user selects the paused plug-in content for playing (step 150). If this is the case, playing of the paused content is resumed (step 155).

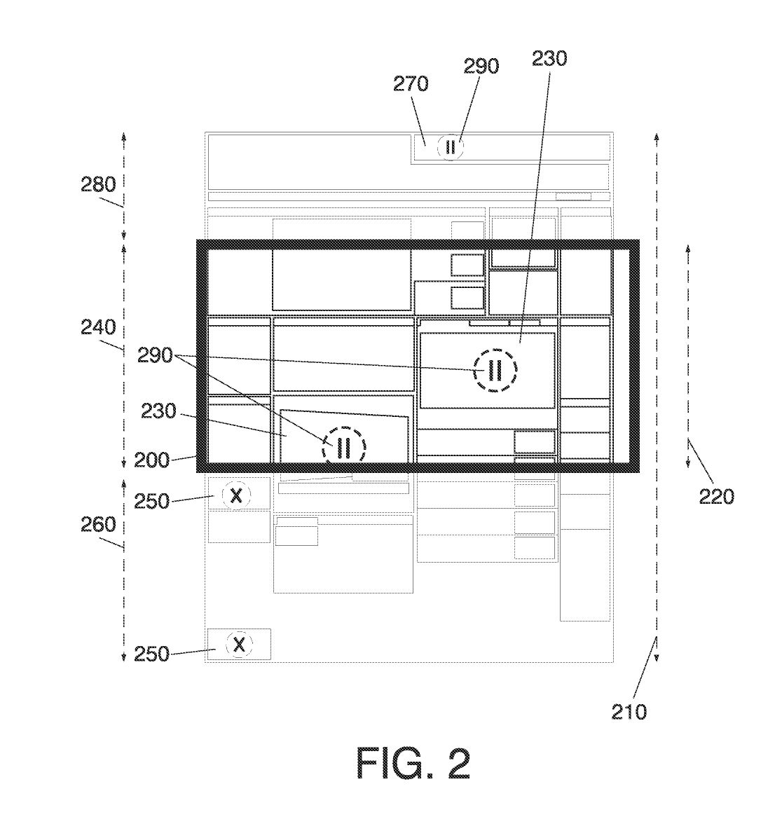

FIG. 2 shows the rendering of the web page on a TV screen 200. Generally, the content height 210 of the web page is larger than the screen height 220 of the TV screen. Plug-in content 230 at locations in the visible part 240 of the web page is in the initialized state, is selectable and can be playing. The plug-in content in the initialized and selectable state has a pause sign 290 superimposed on the paused image thereof, thereby indicating to the user that the plug-in content is initialized (paused) and selectable. Plug-in content 250 in the part 260 of the web page, which has not been visible yet, is in the non-initialized state, is not selectable and is not playing. Plug-in content 270 in the part 280 of the web page, which is not visible in the current view but has been visible before, is in the initialized state but is not selectable and not playing. This content also has a pause sign 290 superimposed on the paused image thereof, but this is not visible to the user.

Now turning to FIG. 1 again, it is determined if the playing content becomes invisible due to user scrolling of the page (step 160). If this is the case, the playing of the content is discontinued (the content is “auto-paused”) and it is set to the non-selectable state (step 165).

Next, it is determined if the plug-in content for which the playing was discontinued becomes visible again (step 170). If this is the case, playing is automatically resumed (step 155). According to an alternative implementation, the plug-in content is reset to the initialized and selectable state and the user should select it for resuming the playing thereof.

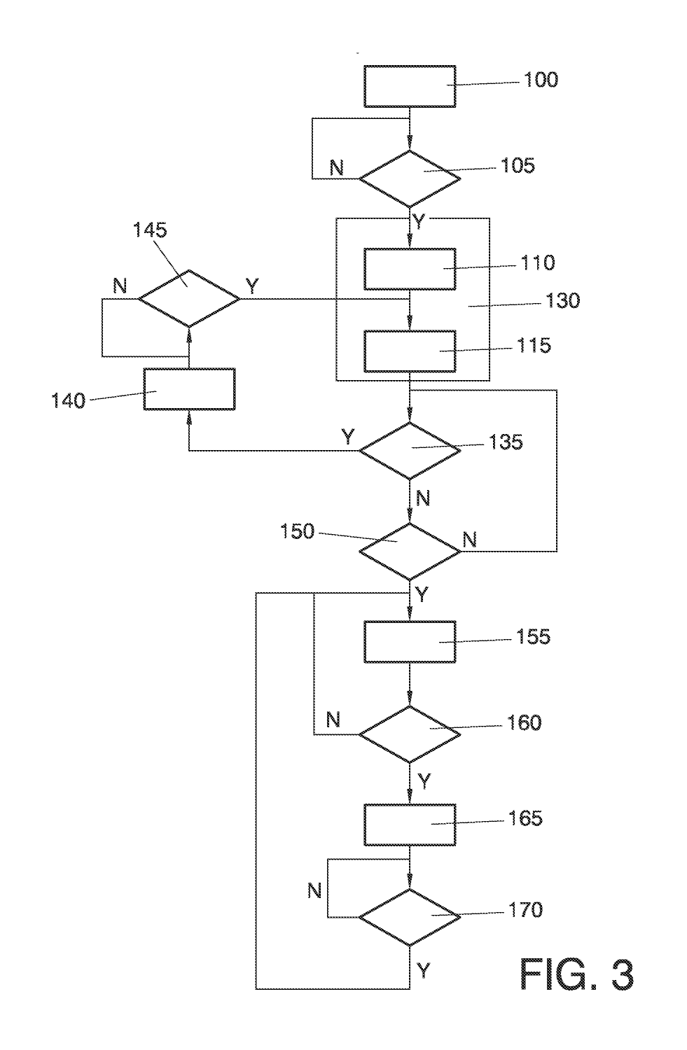

FIG. 3 shows a second exemplary embodiment of the rendering of a web page according to the present invention. Herein, the step of initializing the plug-in content is omitted. Consequently, no memory resources are needed for storing initialized plug-in content, which has not yet been selected for playing by the user. However, the user has to take the decision which plug-in content to select for playing without any information regarding the content.

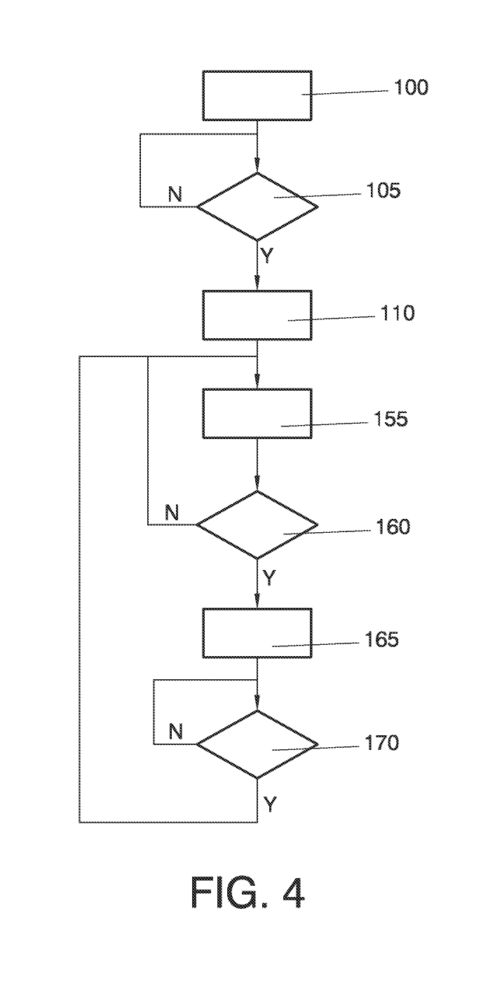

According to a third exemplary embodiment as shown in FIG. 4, the plug-in content corresponding to a location is automatically played as soon as the location becomes visible in a current view of the web page. Consequently, there is no need for the user to select the content for playing. Although, the savings in use of the processor and memory resources are less than in the first and second embodiments, they are still considerable compared to prior art methods of rendering plug-in content wherein all plug-in content in a web page is played from the start, independently of the location thereof (visible or non-visible).

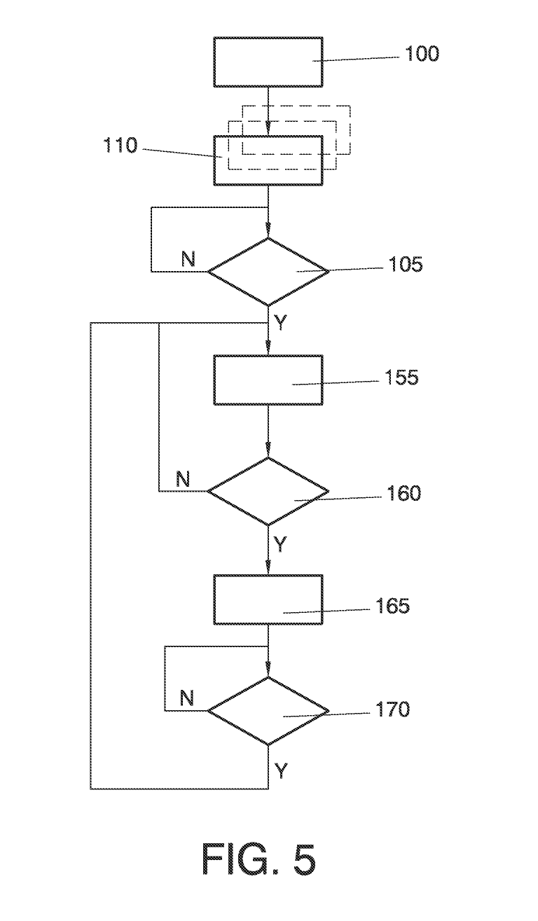

According to a fourth exemplary embodiment as shown in FIG. 5, all plug-ins for playing content in the web page are initialized 110, independently of the position of the corresponding plug-in content. Then, as soon as the location of a plug-in content becomes visible it is automatically played without the need for any user intervention in the same way as in the third embodiment. Compared to the third embodiment, the playing of the content starts a little faster after the content becoming visible, because the plug-in has already been initialized beforehand. However, the drawback is the somewhat higher resource consumption in terms of processing and memory capacity.

A further possibility is to not only initialize all plug-ins but also all plug-in content in the web page, independently of the position thereof. Then, as soon as the location of a plug-in content becomes visible it is automatically played without the need for any user intervention.

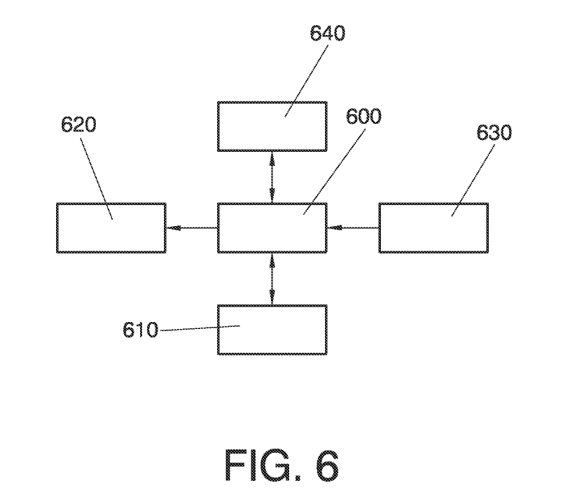

FIG. 6 shows a block diagram of an exemplary system for implementing the present invention. Only those features relevant for generating the present invention are shown. It comprises a controller (processor) 600 with an associated memory 610, a display (e.g. a TV screen) 620, an input device 630 (e.g. a remote control) enabling the user to provide input commands and an interface unit 640, such as a router or modem for connection to the Internet. The functionality shown in FIGS. 1-5 is preferably implemented by means of a suitable computer program loaded to the associated memory of the processor 610. The system is preferably used in devices with limited resources in terms of processing power and memory, such as television sets, mobile telephones, low-end PCs and net-books.

While the invention has been illustrated and described in detail in the drawings and foregoing description, such illustration and description are to be considered illustrative or exemplary and not restrictive; the invention is not limited to the disclosed embodiments.

In this regard it is to be noted that plug-ins are also often referred to as add-ins, add-ons or snap-ins. However, the meaning of these terms is equivalent to plug-in, i.e. they refer to an auxiliary computer program that interacts with the web browser to provide a certain functionality. For this reason, the term “plug-in” in the appended claims should be interpreted to embrace also these alternative terms that have an equivalent meaning

Furthermore, instead of performing step 130 of enabling a user to select the plug-in content or step 155 of automatically playing the plug-in content for all visible plug-in content, this step may be performed for only a part of the visible plug-in content.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. Method of rendering a web page comprising plug-in content, the method comprising the step of:
when a location of plug-in content becomes visible in a current view (220) of the web page, performing a predetermined operation related to the plug-in content corresponding to the location.

2. Method according to claim 1, wherein the predetermined operation comprises the step of enabling a user to select the plug-in content corresponding to the location for playing (130).

3. Method according to claim 2 wherein the step of enabling comprises initializing the plug-in content (115,120).

4. Method according to claim 3, wherein the initializing of the plug-in content comprises pausing the plug-in content (120).

5. Method according to claim 4, comprising the further steps of:
enabling a user to select the paused plug-in content for playing (125); and
playing the paused plug-in content upon the selection (155).

6. Method according to claim 5, comprising the further step of discontinuing the playing of the plug-in content (165), when the playing plug-in content becomes invisible in a current view of the web page.

7. Method according to claim 2, wherein the step of enabling comprises initializing the plug-in needed to play the plug-in content corresponding to the location (110).

8. Method according to claim 2, wherein the step of enabling comprises initializing at least one of the plug-in content corresponding to the location for playing (115,120) and the plug-in needed to play the plug-in content corresponding to the location (110).

9. Method according to claim 1, wherein the predetermined operation is playing the plug-in content (155).

10. Method according to claim 9, comprising the further step of discontinuing the playing of the plug-in content (165), when the playing plug-in content becomes invisible in a current view (220) of the web page.

11. A computer program comprising computer program code means adapted to perform the step according to claim 1 when said program is run on a computer.

12. System comprising a controller (600) for rendering a web page comprising plug-in content, wherein the controller is configured for performing a predetermined operation related to plug-in content, when a location of the plug-in content becomes visible in a current view (220) of the web page.

13. System according to claim 12, wherein the predetermined operation comprises the enabling of a user to select the plug-in content corresponding to the location for playing.

14. System according to claim 13, wherein the enabling comprises initializing at least one of the plug-in content corresponding to the location for playing and the plug-in needed to play the plug-in content corresponding to the location.

15. System according to claim 12, wherein the predetermined operation is playing the plug-in content.
